(19) United States
(12) Patent Application Publication
(10) Pub. No.: US 2026/0176185 A1
(43) Pub. Date: Jun. 25, 2026

(54) GLASS FIBER AND METHOD FOR PRODUCING THE SAME

(71) Applicant: NAN YA PLASTICS CORPORATION, TAIPEI (TW)

(72) Inventors: CHING-YAO YUAN, TAIPEI (TW); WEI-SHENG CHENG, TAIPEI (TW); CHIA-CHEN SU, TAIPEI (TW)

(21) Appl. No.: 19/061,924

(22) Filed: Feb. 24, 2025

(30) Foreign Application Priority Data
Dec. 19, 2024 (TW) 113149512

(51) Int. Cl. C03B 37/023; C03B 37/014

(52) U.S. Cl. CPC C03B 37/023; C03B 37/01446; C03B 2205/69

(57) ABSTRACT

A glass fiber and method for producing the same are provided. The method for producing the glass fiber includes a covering process, a sintering process, a mixing process, and a drawing process. The covering process is implemented by covering a plurality of zirconia powders onto a plurality of surfaces of a plurality of inorganic particles to form a plurality of modified inorganic particles. The sintering process is implemented by sintering the modified inorganic powders at a nitrogen atmosphere and at a temperature of between 400° C. and 1,000° C. The mixing process is implemented by mixing the modified inorganic particles that are sintered into a glass raw material that is in a molten state. The drawing process is implemented by drawing the glass raw material mixed with the modified inorganic particles to form a glass fiber.

### CROSS-REFERENCE TO RELATED PATENT APPLICATION

This application claims the benefit of priority to Taiwan Patent Application No. 113149512, filed on Dec. 19, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a glass fiber and method for producing the same, and more particularly to a glass fiber including zirconia and method for producing the same.

### BACKGROUND OF THE DISCLOSURE

A glass fiber produced by a conventional method for producing a glass fiber has insufficient heat stability.

### SUMMARY OF THE DISCLOSURE

In response to the above-referenced technical inadequacy, the present disclosure provides a glass fiber and method for producing the same, so as to effectively improve on about the problem of a glass fiber produced by a conventional method having insufficient heat stability.

In order to solve the above-mentioned problems, one of the technical aspects adopted by the present disclosure is to provide a method for producing a glass fiber. The method for producing the glass fiber includes a covering process, a mixing process, a sintering process, and a mixing process. The covering process is implemented by covering a plurality of zirconia powders onto a plurality of surfaces of a plurality of inorganic particles to form a plurality of modified inorganic particles. Based on a total weight of each of the modified inorganic particles being 100 wt %, a content of the zirconia powders is between 0.01 wt % and 5 wt %, and a content of the inorganic particle is between 95 wt % and 99.99 wt %. The sintering process is implemented by sintering the modified inorganic particles in a nitrogen atmosphere under a temperature of between 400° C. and 1,000° C. The mixing process is implemented by mixing the modified inorganic particles that are sintered into a glass raw material that is in a molten state. The drawing process is implemented by drawing the glass raw material having the modified inorganic particles mixed therein to form a glass fiber.

In one of the possible or preferred embodiments, the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

In one of the possible or preferred embodiments, an average particle size of the modified inorganic particles is between 0.01 μm and 50 μm.

In one of the possible or preferred embodiments, based on a total weight of the glass fiber being 100 wt %, a content of the modified inorganic particles is between 0.1 wt % and 5 wt %, and a content of the glass raw material is between 95 wt % and 99.9 wt %.

In one of the possible or preferred embodiments, in the covering process, the zirconia powders are dispersed in water to form a solution, and the solution is sprayed onto the inorganic particles, such that the zirconia powders cover onto the inorganic particles to form the modified inorganic particles.

In one of the possible or preferred embodiments, in the covering process, a zirconium compound is dissolved in water and the inorganic particles are added into water, such that the inorganic particles have the zirconium compound formed thereon, and then the inorganic particles and the zirconium compound are heated at a heating temperature of between 100° C. and 140° C., such that the zirconium compound reacts to form the zirconia powders and covers onto the surfaces of the inorganic particles, and the modified inorganic particles are formed.

In one of the possible or preferred embodiments, the zirconium compound is selected from the group consisting of zirconium oxychloride, zirconium carbonate, zirconium hydroxide, zirconium nitrate, sodium zirconate, and zirconium silicate.

In one of the possible or preferred embodiments, based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide.

In one of the possible or preferred embodiments, a thermal expansion coefficient of the glass fiber is between 2.88 PPM/° C. and 3.34 PPM/° C.

In order to solve the above-mentioned problems, another one of the technical aspects adopted by the present disclosure is to provide a glass fiber. The glass fiber includes a glass raw material and a plurality of modified inorganic particles. The modified inorganic particles are dispersed in the glass raw material. Each of the modified inorganic particles includes an inorganic particle and a plurality of zirconia powders covering on the inorganic particle. Based on a total weight of each of the modified inorganic particles being 100 wt %, a content of the zirconia powders is between 0.01 wt % and 5 wt %, and a content of the inorganic particle is between 95 wt % and 99.99 wt %. The inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

In one of the possible or preferred embodiments, an average particle size of the modified inorganic particles is between 0.01 μm and 50 μm.

In one of the possible or preferred embodiments, based on a total weight of the glass fiber being 100 wt %, a content of the modified inorganic particles is between 0.1 wt % and 5 wt %, and a content of the glass raw material is between 95 wt % and 99.9 wt %.

In one of the possible or preferred embodiments, based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide.

In one of the possible or preferred embodiments, a thermal expansion coefficient of the glass fiber is between 2.88 PPM/° C. and 3.34 PPM/° C.

Therefore, in the glass fiber and method for producing the same provided by the present disclosure, by virtue of “the covering process, the sintering process, the mixing process, and the drawing process,” “based on the total weight of each of the modified inorganic particles being 100 wt %, the content of the zirconia powders being between 0.01 wt % and 5 wt %, and the content of the inorganic particle being between 95 wt % and 99.99 wt %,” and “the modified inorganic particles being dispersed in the glass raw material,” the problem of the glass fiber produced by the conventional method having insufficient heat stability can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a glass fiber according to an embodiment of the present disclosure;

FIG. 2 is a schematic view of a glass fiber according to the embodiment of the present disclosure; and

FIG. 3 is a schematic view of a modified inorganic particle according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Method for Producing a Glass Fiber]

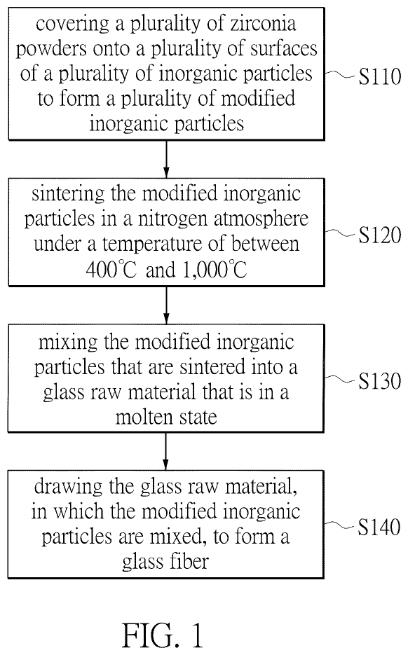

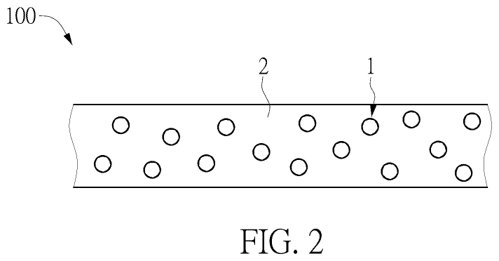

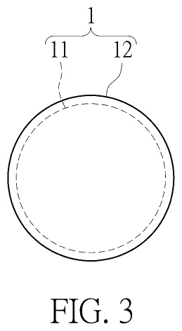

Referring to FIG. 1 to FIG. 3, FIG. 1 is a flowchart of a method for producing a glass fiber according to an embodiment of the present disclosure, FIG. 2 is a schematic view of a glass fiber according to the embodiment of the present disclosure, and FIG. 3 is a schematic view of a modified inorganic particle according to the embodiment of the present disclosure. One embodiment of the present disclosure provides a method for a glass fiber, the method for producing the glass fiber includes a covering process S110, a sintering process S120, a mixing process S130, and a drawing process S140. Naturally, the method for producing the glass fiber can include other process according to practical requirements, but the present disclosure is not limited thereto.

The covering process S110 is implemented by covering a plurality of zirconia powders onto a plurality of surfaces of a plurality of inorganic particles to form a plurality of modified inorganic particles 1. Each of the modified inorganic particles 1 has a core-shell structure, the core-shell structure includes a core layer 11 formed by the inorganic particle and a shell layer 12 formed by the zirconia powders. Based on a total weight of each of the modified inorganic particles being 100 wt %, a content of the zirconia powders is between 0.01 wt % and 5 wt %, and a content of the inorganic particle is between 95 wt % and 99.99 wt %. An average particle size of the modified inorganic particles is between 0.01 μm and 50 μm, but the present disclosure is not limited thereto.

It is worth mentioning that, the inorganic particles have a high temperature resistance. Preferably, the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

In the covering process S110 of one embodiment, the zirconia powders are dispersed in water to form a solution, and the solution is sprayed onto the inorganic particles, such that the zirconia powders cover onto the inorganic particles to form the modified inorganic particles 1. In the present embodiment, the solution can be contained in a sprayer, the solution can be sprayed onto the inorganic particles through the sprayer, the solution and the inorganic particles are stirred, and then water is dried, such that the zirconia powders cover onto the inorganic particles.

In the covering process S110 of another embodiment, a zirconium compound is dissolved in water and the inorganic particles are added into water, such that the inorganic particles have the zirconium compound formed thereon, and then the inorganic particles and the zirconium compound are heated at a heating temperature of between 100° C. and 140° C., such that the zirconium compound reacts to form the zirconia powders and covers onto the surfaces of the inorganic particles to the form inorganic particles 1. The zirconium compound can be selected from the group consisting of zirconium oxychloride, zirconium carbonate, zirconium hydroxide, zirconium nitrate, sodium zirconate, and zirconium silicate, but the present disclosure is not limited thereto.

The sintering process S120 is implemented by sintering the modified inorganic particles 1 in a nitrogen atmosphere under a temperature of between 400° C. and 1,000° C. The nitrogen atmosphere refers to a pure nitrogen environment, since the modified inorganic particles 1 are sintered in the nitrogen atmosphere, the formation of side-products can be reduced. Through the sintering process S120, the modified inorganic particles 1 undergo lattice rearrangement, such that zirconia is inserted into the crystal lattice of the inorganic particles 1. In this way, zirconia does not easily detach from the surfaces of the inorganic particles.

The mixing process S130 implemented by mixing the modified inorganic particles 1 that are sintered, into a glass raw material 2 that is in a molten state. In the present embodiment, based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide. The alkali metal oxide is selected from the group consisting of lithium oxide, sodium oxide, potassium oxide, rubidium oxide, and cesium oxide.

The drawing process S140 is implemented by drawing the glass raw material 2 having the modified inorganic particles 1 mixed therein to form a glass fiber 100. In the present embodiment, based on a total weight of the glass fiber being 100 wt %, a content of the modified inorganic particles 1 is between 0.1 wt % and 5 wt %, and a content of the glass raw material 2 is between 95 wt % and 99.9 wt %.

It is worth mentioning that, in the method for producing the glass fiber, the zirconia powders cover onto the surfaces of the inorganic particles to form the modified inorganic particles 1, and then the modified inorganic particles 1 are mixed in the glass raw material 2, such that the zirconia powders can be evenly dispersed in the glass raw material 2. In this way, the glass fiber 100 can have a relatively high heat resistance, and a thermal expansion coefficient of the glass fiber 100 is between 2.88 PPM/° C. and 3.34 PPM/° C.

### [Glass Fiber]

The embodiment of the present embodiment further provides a glass fiber 100. The glass fiber 100 can be obtained by implementing the above-mentioned method for producing the glass fiber, but the present disclosure is not limited thereto.

The glass fiber 100 includes a glass raw material 2 and a plurality of modified inorganic particles 1 dispersed in the glass raw material 2. Each of the modified inorganic particles 1 includes an inorganic particle and a plurality of zirconia powders covering on the inorganic particle. Based on a total weight of each of the modified inorganic particles being 100 wt %, a content of the zirconia powders is between 0.01 wt % and 5 wt %, and a content of the inorganic particle is between 95 wt % and 99.99 wt %.

The inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica. An average particle size of the modified inorganic particles is between 0.01 μm and 50 μm.

Based on a total weight of the glass fiber being 100 wt %, a content of the modified inorganic particles is between 0.1 wt % and 5 wt %, and a content of the glass raw material is between 95 wt % and 99.9 wt %, but the present disclosure is not limited thereto.

Based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide, but the present disclosure is not limited thereto.

It is worth mentioning that zirconia has a high melting point and an excellent heat resistance. Accordingly, zirconia powder can maintain structural stability in a high temperature environment and does not easily expand or deform. In addition, zirconia can convert between different crystal phases at different temperatures to absorb heat. Accordingly, a thermal expansion coefficient of the glass fiber is between 2.88 PPM/° C. and 3.34 PPM/° C.

### [Experimental Results]

Hereinafter, a more detailed description will be provided with reference to Exemplary Examples 1 to 10 and Comparative Example 1. However, the following Exemplary Examples are only used to aid in understanding of the present disclosure, and are not to be construed as limiting the scope of the present disclosure.

In Comparative Example 1, no modified inorganic particle is added. In the method for producing the glass fiber of each of the Exemplary Examples 1 to 5, based on the total weight of the glass fiber being 100 wt %, the contents of the modified inorganic particles are respectively, 0.01 wt %, 0.05 wt %, 0.1 wt %, 0.5 wt %, and 1 wt %, and the contents of the glass raw material are respectively 99.99 wt %, 99.95 wt %, 99.9 wt %, 99.5 wt %, and 99 wt %. In the method for producing the glass fiber of Exemplary Examples 6 to 10, zirconium silicate, zirconium oxychloride, zirconium carbonate, zirconium hydroxide, and zirconium nitrate are respectively used as the zirconium compounds. In the method for producing the glass fiber of Exemplary Examples 6 to 10, based on the total weight of the glass fiber being 100 wt %, the content of the modified inorganic particles is 0.1 wt %, and the content of the glass raw material is 99.9 wt %.

The thermal expansion coefficient is measured by a thermomechanical analyzer according to ASTM E831 standard.

TABLE 1
[glass fiber including modified inorganic particles having
different contents and thermal expansion coefficients thereof]

| | Comparative | Exemplary | Exemplary | Exemplary | Exemplary | Exemplary |
|---|---|---|---|---|---|---|
| Item | Example 1 | Example 1 | Example 2 | Example 3 | Example 4 | Example 5 |
| Content of | 0 | 0.01 | 0.05 | 0.1 | 0.5 | 1 |
| modified | | | | | | |
| inorganic | | | | | | |
| particle | | | | | | |
| (wt %) | | | | | | |
| Thermal | 3.5 | 3.34 | 3.04 | 2.88 | 2.89 | 2.90 |
| expansion | | | | | | |
| coefficient | | | | | | |
| (PPM/° C.) | | | | | | |

TABLE 2
[glass fibers with different zirconium compounds
and thermal expansion coefficients thereof]

| | Comparative | Exemplary | Exemplary | Exemplary | Exemplary | Exemplary |
|---|---|---|---|---|---|---|
| Item | Example 1 | Example 6 | Example 7 | Example 8 | Example 9 | Example 10 |
| Content of | 0 | 0.1 | 0.1 | 0.1 | 0.1 | 0.1 |
| modified | | | | | | |
| inorganic | | | | | | |
| particle | | | | | | |
| (wt %) | | | | | | |
| Material of | None | ZrSiO₄ | ZrOCl₂ | ZrCO₃ | Zr(OH)₄ | Zr(NO₃)₄ |
| zirconium | | | | | | |
| compound | | | | | | |
| Thermal | 3.5 | 2.88 | 2.94 | 2.98 | 3.04 | 3.10 |
| expansion | | | | | | |
| coefficient | | | | | | |
| (PPM/° C.) | | | | | | |

### [Discussion of Test Results]

As shown in Comparative Example 1 and Exemplary Examples 1 to 5, the glass fiber of Comparative Example 1 is not added with modified inorganic particle, thereby causing the high thermal expansion coefficient of the glass fiber. As shown in Comparative Example 1 and Exemplary Examples 6 to 10, zirconium silicate, zirconium oxychloride, zirconium carbonate, zirconium hydroxide, and zirconium nitrate can be used as the zirconium compound, the thermal expansion coefficient of the glass fiber in each of Exemplary Examples 6 to 10 is lower than the thermal expansion coefficient of the glass fiber in Comparative Example 1.

### [Beneficial Effects of the Embodiment]

In conclusion, in the glass fiber and method for producing the same provided by the present disclosure, by virtue of “the covering process, the sintering process, the mixing process, and the drawing process,” “based on the total weight of each of the modified inorganic particles being 100 wt %, the content of the zirconia powders being between 0.01 wt % and 5 wt %, and the content of the inorganic particle being between 95 wt % and 99.99 wt %,” and “the modified inorganic particles being dispersed in the glass raw material,” the problem of the glass fiber produced by the conventional method having the insufficient heat stability can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a glass fiber, comprising:
a covering process implemented by covering a plurality of zirconia powders onto a plurality of surfaces of a plurality of inorganic particles to form a plurality of modified inorganic particles; wherein, based on a total weight of each of the modified inorganic particles being 100 wt %, a content of the zirconia powders is between 0.01 wt % and 5 wt %, and a content of the inorganic particle is between 95 wt % and 99.99 wt %;
a sintering process implemented by sintering the modified inorganic particles in a nitrogen atmosphere under a temperature of between 400° C. and 1,000° C.;
a mixing process implemented by mixing the modified inorganic particles that are sintered into a glass raw material that is in a molten state; and
a drawing process implemented by drawing the glass raw material, in which the modified inorganic particles are mixed, to form a glass fiber.

2. The method according to claim 1, wherein the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

3. The method according to claim 1, wherein an average particle size of the modified inorganic particles is between 0.01 μm and 50 μm.

4. The method according to claim 1, wherein, based on a total weight of the glass fiber being 100 wt %, a content of the modified inorganic particles is between 0.1 wt % and 5 wt %, and a content of the glass raw material is between 95 wt % and 99.9 wt %.

5. The method according to claim 1, wherein, in the covering process, the zirconia powders are dispersed in water to form a solution, and the solution is sprayed onto the inorganic particles, such that the zirconia powders cover onto the inorganic particles to form the modified inorganic particles.

6. The method according to claim 1, wherein, in the covering process, a zirconium compound is dissolved in water and the inorganic particles are added into water, such that the inorganic particles have the zirconium compound formed thereon, and then the inorganic particles and the zirconium compound are heated at a heating temperature of between 100° C. and 140° C., such that the zirconium compound reacts to form the zirconia powders and covers onto the surfaces of the inorganic particles to form the modified inorganic particles.

7. The method according to claim 6, wherein the zirconium compound is selected from the group consisting of zirconium oxychloride, zirconium carbonate, zirconium hydroxide, zirconium nitrate, sodium zirconate, and zirconium silicate.

8. The method according to claim 1, wherein, based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide.

9. The method according to claim 1, wherein a thermal expansion coefficient of the glass fiber is between 2.88 PPM/° C. and 3.34 PPM/° C.

10. A glass fiber, comprising:
a glass raw material; and
a plurality of modified inorganic particles dispersed in the glass raw material; wherein each of the modified inorganic particles includes an inorganic particle and a plurality of zirconia powders covering on the inorganic particle; wherein, based on a total weight of each of the modified inorganic particles being 100 wt %, a content of the zirconia powders is between 0.01 wt % and 5 wt %, and a content of the inorganic particle is between 95 wt % and 99.99 wt %;
wherein the inorganic particles are selected from the group consisting of silicon dioxide, titanium dioxide, aluminum hydroxide, magnesium hydroxide, calcium carbonate, aluminum oxide, magnesium oxide, talc, aluminum nitride, boron nitride, silicon carbide, zinc oxide, zirconium oxide, quartz, diamond powder, diamond-like powder, graphite, calcined kaolin, and fumed silica.

11. The glass fiber according to claim 10, wherein an average particle size of the modified inorganic particles is between 0.01 μm and 50 μm.

12. The glass fiber according to claim 10, wherein, based on a total weight of the glass fiber being 100 wt %, a content of the modified inorganic particles is between 0.1 wt % and 5 wt %, and a content of the glass raw material is between 95 wt % and 99.9 wt %.

13. The glass fiber according to claim 10, wherein, based on a total weight of the glass raw material being 100 wt %, the glass raw material includes 59 wt % to 66 wt % of silicone dioxide, 15 wt % to 26 wt % of aluminum oxide, 8 wt % to 12 wt % of magnesium oxide, 0.1 wt % to 4 wt % of calcium oxide, 0.1 wt % to 10 wt % of boron trioxide, and 0.1 wt % to 2 wt % of alkali metal oxide.

14. The glass fiber according to claim 10, wherein a thermal expansion coefficient of the glass fiber is between 2.88 PPM/° C. and 3.34 PPM/° C.
